(19) United States
(12) Patent Application Publication
(10) Pub. No.: US 2013/0086040 A1
(43) Pub. Date: Apr. 4, 2013

(54) SYSTEMS AND METHODS FOR DYNAMIC ON-GOING DECISION SUPPORT AND TRENDING BASED ON A FLEXIBLE DATA MODEL

(71) Applicants: Arpita Patadia, Barrington, IL (US); Robert Whitney, Barrington, IL (US); York W. Davis, Barrington, IL (US); Rajakumari Pavuluri, Barrington, IL (US); Muhammad Azhar, Barrington, IL (US)

(72) Inventors: Arpita Patadia, Barrington, IL (US); Robert Whitney, Barrington, IL (US); York W. Davis, Barrington, IL (US); Rajakumari Pavuluri, Barrington, IL (US); Muhammad Azhar, Barrington, IL (US)

(73) Assignee: General Electric Company, Schenectady (NY)

(21) Appl. No.: 13/250,045

(22) Filed: Sep. 30, 2011

(51) Int. Cl. G06F 17/30

(52) U.S. Cl. 707/722; 707/E17.014

(57) ABSTRACT

Certain examples provide systems, methods, apparatus, and articles of manufacture for clinical data analysis. Certain examples provide a clinical data analysis system including a user interface, a task manager, and a process manager. The example user interface is to facilitate user input and provide output to the user regarding a data query and analysis. The example task manager is to create and manage one or more analyzers to identify at least one of a trend and a correlation in query results. The example process manager is to facilitate querying of one or more data sources according to the data query and a flexible data model, the process manager to allocate tasks to the one or more analyzers for the data query and analysis. The example process manager and task manager are to facilitate user queries and automated system queries performed automatically during periods of non-peak usage.

### FIELD OF THE DISCLOSURE

The present disclosure relates generally to healthcare information systems and, more particularly, to methods, systems, apparatus, and articles of manufacture for dynamic analysis and decision support based on a flexible clinical data model.

### BACKGROUND

Healthcare environments, such as hospitals and clinics, typically include information systems (e.g., electronic medical record (EMR) systems, lab information systems, outpatient and inpatient systems, hospital information systems (HIS), radiology information systems (RIS), storage systems, picture archiving and communication systems (PACS), etc.) to manage clinical information such as, for example, patient medical histories, imaging data, test results, diagnosis information, management information, financial information, and/or scheduling information. These healthcare information systems are used to implement different types of workflows in which clinical information is generated, updated, augmented, and/or otherwise processed for one or more purposes.

### BRIEF SUMMARY

Certain examples provide systems, methods, apparatus, and articles of manufacture for clinical data analysis.

Certain examples provide a clinical data analysis system including a user interface, a task manager, and a process manager. The example user interface is to facilitate user input and provide output to the user regarding a data query and analysis. The example task manager is to create and manage one or more analyzers to identify at least one of a trend and a correlation in query results. The example process manager is to facilitate querying of one or more data sources according to the data query and a flexible data model, the process manager to allocate tasks to the one or more analyzers for the data query and analysis. The example process manager and task manager are to facilitate user queries and automated system queries performed automatically during periods of non-peak usage.

Certain examples provide a tangible computer-readable storage medium including a set of instructions, which when executed by a processor, implement a clinical data analysis system. The example clinical data analysis system includes a user interface, a task manager, and a process manager. The example user interface is to facilitate user input and provide output to the user regarding a data query and analysis. The example task manager is to create and manage one or more analyzers to identify at least one of a trend and a correlation in query results. The example process manager is to facilitate querying of one or more data sources according to the data query and a flexible data model, the process manager to allocate tasks to the one or more analyzers for the data query and analysis. The example process manager and task manager are to facilitate user queries and automated system queries performed automatically during periods of non-peak usage.

Certain examples provide a computer-implemented method of clinical data query and analysis. The example method includes formulating a data query for clinical data, the data query comprising at least one of a user-generated query and an automatically-generated query. The example method includes creating, including a processor, one or more analyzers to identify at least one of a trend and a correlation in query results. The example method includes facilitating, using a processor, querying of one or more data sources according to the data query and a flexible data model. In the example method, tasks are to be allocated to the one or more analyzers for data query and analysis. The example method includes providing analysis results in an output to a user. In the example method, the processor and the one or more analyzers are to facilitate user queries and automated system queries performed automatically during periods of non-peak usage.

### BRIEF DESCRIPTION OF SEVERAL VIEWS OF THE DRAWINGS

FIG. 1 is a block diagram of an example healthcare environment in which the example methods, apparatus, systems and/or articles of manufacture described herein to organize healthcare information may be implemented.

FIG. 2 illustrates an example clinical knowledge system providing an aggregation of data from multiple sources.

FIG. 3 illustrates an example interdependence of content types.

FIG. 4 illustrates an example hierarchy of content, associated data models, and terminology.

FIG. 5 shows an example of a root content item with one or more content variants and one or more context variants.

FIG. 6 provides an example multi-patient view made up of a plurality of formlets and a frameset.

FIG. 7 illustrates an example decision support and trending system to operate on clinical data, such as data formatted for clinical element models.

FIG. 8 illustrates a flow diagram for an example method of dynamic, on-going decision support and trending based on a flexible data model.

FIG. 9 illustrates a block diagram of an example processor system that can be used to implement the apparatus and methods described herein.

The foregoing summary, as well as the following detailed description of certain examples of the present invention, will be better understood when read in conjunction with the appended drawings. For the purpose of illustrating the invention, certain examples are shown in the drawings. It should be understood, however, that the present invention is not limited to the arrangements and instrumentality shown in the attached drawings.

### DETAILED DESCRIPTION

Although the following discloses example methods, apparatus, systems, and articles of manufacture including, among other components, firmware and/or software executed on hardware, it should be noted that such methods, apparatus, systems, and/or articles of manufacture are merely illustrative and should not be considered as limiting. For example, it is contemplated that any or all of these firmware, hardware, and/or software components could be embodied exclusively in hardware, exclusively in software, exclusively in firmware, or in any combination of hardware, software, and/or firmware. Accordingly, while the following describes example methods, apparatus, systems, and/or articles of manufacture, the examples provided are not the only way(s) to implement such methods, apparatus, systems, and/or articles of manufacture.

Certain examples provide a dynamic data trend analysis and reporting engine for a clinical system. The dynamic data trend analysis and reporting engine uses data from a dynamic and flexible data model to improve patient care by finding correlations, trends, and relationships between available data in the clinical system and with data from external systems. Fields can be added dynamically by updating the data model, and the new data is automatically made available for trending. The dynamic data trend analysis and reporting engine can compute correlation/trending based on one or more fields inputted by a user, for example.

For example, a correlation can indicate a mutual relation of two or more items (e.g., data items). A correlation can represent a degree to which two or more attributes show a tendency to vary together. A trend represents a general course or prevailing tendency, for example. Trending can show that certain data tend to take a particular direction, for example.

Certain examples provide a “smart” engine that performs automatic data mining during idle time and finds correlations/trends on its own (e.g., by looking for unexpected results and/or values by correlating unrelated items). During idle time, the engine can also perform searches based on previous searches performed by users in order to find correlations/trends that may be of interest to users. Correlations found by the engine can be used by clinicians to help with decision support and to create automatic alerts to assist in clinical processes, for example.

In certain examples, the dynamic data trend analysis and reporting engine enables automatic data review and correlation in a clinical setting. Trending can be configured via a rules engine allowing customizations dynamically without code changes. Certain examples allow for generation of alert notifications.

In certain examples, trending is performed in at least two ways. First, users can select the data that they wish to have trended. Second, trends can be dynamically reported based on available data.

The dynamic data model allows the engine to have a user, rather than a programmer, make adjustments to work with new information rather than particularly coded logic. Adding new fields and models to the data model results in new data being available against which the engine can perform correlation/trending.

In certain examples, the engine can work with data from external sources as well as additional sources of clinical information. The engine supports distributed processing so it can perform search across multiple systems, for example. Examples of external sources include a weather system, a stock market, a geographical map, etc. Examples of additional sources of clinical system include other hospitals that use the same data model, clinical document repositories for clinical document architecture (CDA) documents, etc. Example users include analyst researchers, clinicians such as doctors, nurses, etc.

In certain examples, searches can be associated with different, configurable priorities. For example, clinicians may have a higher level of importance when running searches over researchers based on available processing capability.

In certain examples, trending provided by the engine can be configurable. For example, the user can specify certain categories and/or criteria based on the available data. Restricting searches allows for finding of trends using less processing power and expanding the search to include more data. For example, searches can be restricted among certain domain(s). Searches can be limited to only males over age sixty, for example. Searches can be limited to a particular geographic area, for example. For example, data can be provided via a map-based representation such that a user can select a location on a map and view data points associated with the selected location (e.g., look inside a selected hospital). A user can select type(s) of data from a patient record and perform one or more geographic searches, for example.

In certain examples, layered data combination and/or trending is facilitated. For example, results of previous searches/analyses can be input as a starting point for subsequent searches. Searches can be expanded or narrowed in this way, for example. For example, results of a search correlating high blood pressure to height can be expanded to account for a geographical area (e.g., local, regional, national, etc.). Regional problems can also be explored, for example, to find a relationship in one area that is not seen in other areas. Then, other hospitals in a selected area can be queried for the same relationship. Search results may show a difference in results in rural versus urban areas.

In certain examples, one data point can be used to find relationships that were previously unappreciated and/or unexamined. For example, a search can be limited to one or more particular age groups, and the engine is allowed to find correlations.

In certain examples, the engine includes two automatic processes that run during idle processing time: a self-discovery mechanism and a smart engine feature. The self-discovery mechanism of the engine allows for the engine to do automatic trending. Random discovery can provide unexpected results by associating data that is not normally correlated, for example. Example can include weather and illness, stock market and heart attacks, people over six feet tall admitted before noon, etc.

The smart engine feature allows the engine to use previous searches requested by users to run similar searches as well as searches based on the results of user-run searches. Statistically relevant correlations (also referred to as high correlations) are sent back into the system to find further correlations.

Certain examples also provide decision support and alerting. By finding relevant correlations/trends, a user can add an alert to be notified of a similar situation in the future. For example, a relationship is found between five consecutive days of cloudy weather and increase in depression.

In certain examples, the engine is configured to find correlations on items that are input by a user, as well as to perform automatic searches on random, unrelated items to find unique correlations that may not have been considered by a user. These results can be used to help the care of patients by improving decision support and creating alerts, for example. The engine can be used by a variety of users including analyst researchers and clinicians (e.g., doctors, nurses, etc.).

Certain examples help to improve healthcare through discovery of relevant trends and correlations. Certain examples use identified relationships for improved decision support to create alerts so that, if a situation arises in the future, an alert is generated. Certain examples help to improve patient care and make patient care safer, find problems earlier, and allow for more preventative care. Certain examples find meaningful trends/relationships between data that appears to be completed unrelated.

Searches can be broad or narrow as desired. For example, a search can be narrowed focused by creating limiting filters on particular fields. For example, a search can be broadened by including an external data source/system and using the smart engine functionality to identify trends/correlations and data points available from both the base and external data sources.

In certain examples, new data can be introduced by updating a flexible data model to input new data into the system, and the new data can be made available to the engine to be included for correlation/trending.

Certain examples provide a capability to perform analysis and correlations automatically during non-peak or “off” hours. Certain examples provide flexibility in that a data model can be modified dynamically, and the new data is automatically made available for trending.

Entities of healthcare enterprises operate according to a plurality of clinical workflows. Clinical workflows are typically defined to include one or more steps or actions to be taken in response to one or more events and/or according to a schedule. Events may include receiving a healthcare message associated with one or more aspects of a clinical record, opening a record(s) for new patient(s), receiving a transferred patient, and/or any other instance and/or situation that requires or dictates responsive action or processing. The actions or steps of a clinical workflow may include placing an order for one or more clinical tests, scheduling a procedure, requesting certain information to supplement a received healthcare record, retrieving additional information associated with a patient, providing instructions to a patient and/or a healthcare practitioner associated with the treatment of the patient, and/or any other action useful in processing healthcare information. The defined clinical workflows can include manual actions or steps to be taken by, for example, an administrator or practitioner, electronic actions or steps to be taken by a system or device, and/or a combination of manual and electronic action(s) or step(s). While one entity of a healthcare enterprise may define a clinical workflow for a certain event in a first manner, a second entity of the healthcare enterprise may define a clinical workflow of that event in a second, different manner. In other words, different healthcare entities may treat or respond to the same event or circumstance in different fashions. Differences in workflow approaches may arise from varying preferences, capabilities, requirements or obligations, standards, protocols, etc. among the different healthcare entities.

However, the entities of a healthcare enterprise and/or entities from separate healthcare enterprises sometimes operate within a broader, interdependent information system, which hinder the ability of entities to customize clinical workflows. For example, the information system to which a healthcare entity belongs may place restrictions on changes to workflow applications or programs. Moreover, because some healthcare entities operate using systems, programs, devices, etc. from varying manufactures, software providers, etc., a lack of interoperability between the systems, programs, devices, etc. of each healthcare entity prohibits many customizations from realization. As a consequence of these example factors as well as additional or alternative factors, healthcare entities that desire customized clinical workflows are typically required to request such customizations from the manufactures, software providers, etc. Furthermore, for such customizations to implemented or integrated into a healthcare information system, a wide range of system-interrupting updates or re-releases occur within the information systems.

Certain examples provide a clinical knowledge platform that enables healthcare institutions to improve performance, reduce cost, touch more people, and deliver better quality globally. In certain examples, the clinical knowledge platform enables healthcare delivery organizations to improve performance against their quality targets, resulting in better patient care at a low, appropriate cost.

Certain examples facilitate better control over data. For example, certain example systems and methods enable care providers to access real-time patient information from existing healthcare information technology (IT) systems together in one location and compare this information against evidence-based best practices.

Certain examples facilitate better control over process. For example, certain example systems and methods provide condition- and role-specific patient views enable a user to prioritize and coordinate care efforts with an institution's agreed upon practice standards and to more effectively apply resources.

Certain examples facilitate better control over outcomes. For example, certain example systems and methods provide patient dashboards that highlight variations from desired practice standards and enable care providers to identify most critical measures within the context of performance-based care.

Certain examples leverage existing IT investments to standardize and centralize data across an organization. In certain examples, this includes accessing multiple systems from a single location, while allowing greater data consistency across the systems and users.

In certain examples, an advanced Service-Oriented Architecture (SOA) with a modern technology stack helps provide robust interoperability, reliability, and performance. The example SOA includes a three-fold interoperability strategy including a central repository (e.g., a central repository built from Health Level Seven (HL7) transactions), services for working in federated environments, and visual integration with third-party applications. Certain examples provide portable content enabling plug 'n play content exchange among healthcare organizations. A standardized vocabulary using common standards (e.g., LOINC, SNOMED CT, RxNorm, FDB, ICD-9, ICD-10, etc.) is used for interoperability, for example. Certain examples provide an intuitive user interface to help minimize end-user training. Certain examples facilitate user-initiated launching of third-party applications directly from a desktop interface to help provide a seamless workflow by sharing user, patient, and/or other contexts. Certain examples provide real-time (or at least substantially real time assuming some system delay) patient data from one or more IT systems and facilitate comparison(s) against evidence-based best practices. Certain examples provide one or more dashboards for specific sets of patients. Dashboard(s) can be based on condition, role, and/or other criteria to indicate variation(s) from a desired practice, for example.

Generally, the example methods, apparatus, systems, and/or articles of manufacture disclosed herein enable healthcare entities of an enterprise clinical information system (ECIS) to dynamically customize one or more clinical workflows. Among other functions and/or benefits, the ECIS supports healthcare practitioners in decision making processes by aggregating healthcare information across disparate enterprises and/or entities thereof and referencing collection(s) of data (e.g., guidelines, recommendations related treatment and/or diagnosis, studies, histories, etc.) to automatically generate supportive information to be communicated to one or more healthcare practitioners related to the aggregated healthcare information. While each entity operates in connection with the ECIS that is administered by a provider thereof, the examples disclosed herein enable each entity of operating in connection with the ECIS to originate and/or modify one or more clinical workflows without relying on the provider of the ECIS to do so on behalf of the entity. In other words, although a healthcare entity is part of the ECIS and exchanges data with and via the ECIS, that entity can independently create and/or manage its clinical workflows using the examples disclosed herein. Furthermore, the examples disclosed herein enable entities of the ECIS to deploy or initiate the customized workflows without having to reboot or significantly interrupt the ECIS and/or the other components, workflows, etc., thereof. The example methods, apparatus, systems, and/or articles of manufacture disclosed herein and the advantages and/or benefits thereof are described in greater detail below in connection with the figures.

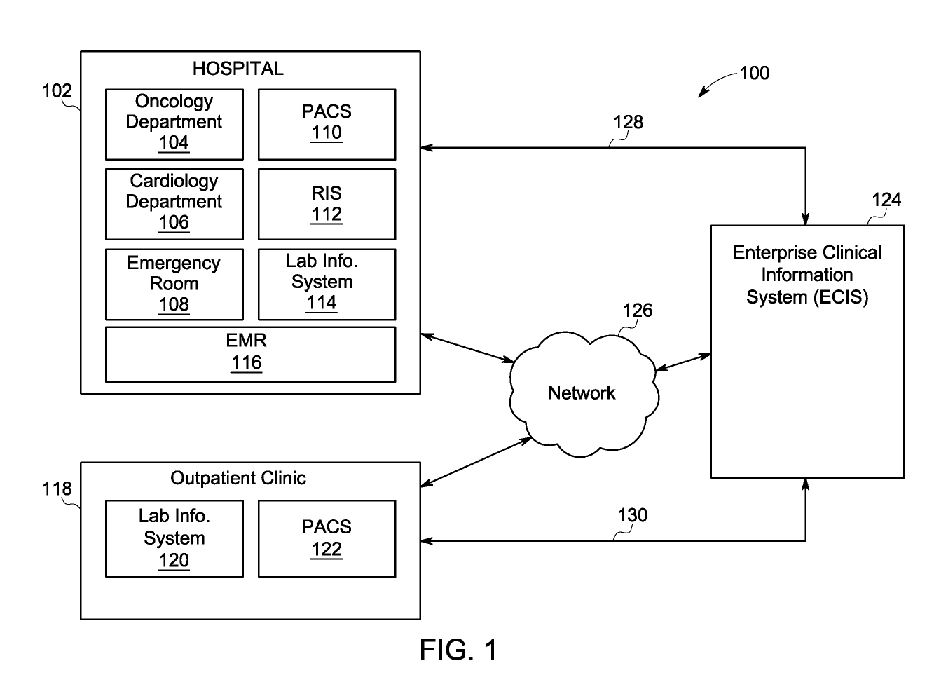

FIG. 1 is a block diagram of an example healthcare environment 100 in which the example methods, apparatus, systems, and/or articles of manufacture disclosed herein for clinical content-based healthcare may be implemented. The example healthcare environment 100 of FIG. 1 includes a first hospital 102 having a plurality of entities operating within and/or in association with the first hospital 102. In the illustrated example, the entities of the first hospital 102 include an oncology department 104, a cardiology department 106, an emergency room system 108, a picture archiving and communication system (PACS) 110, a radiology information system (RIS) 112, and a laboratory information system (LIS) 114. The oncology department 104 includes cancer-related healthcare practitioners, staff and the devices or systems that support oncology practices and treatments. Similarly, the cardiology department 106 includes cardiology-related healthcare practitioners, staff and the devices and/or systems that support cardiology practices and treatments. Notably, the example oncology department 104 of FIG. 1 has specifically designed clinical workflows to be executed in response to certain events and/or according to a schedule. At the same time, the example cardiology department 106 of FIG. 1 has specifically designed clinical workflows to be executed in response to certain events and/or according to a schedule that differ from the clinical workflows of the example oncology department 104 of FIG. 1. For example, the oncology department 104 may execute a first set of actions in response to receiving a Healthcare Level 7 (HL7) admission-discharge-transfer (ADT) message, while the cardiology department 106 executes a second set of actions different from the first set of actions in response to receiving a HL7 ADT message. Such differences may also exist between the emergency room 108, the PACS 110, the RIS 112 and/or the accounting services 114.

Briefly, the emergency room system 108 manages information related to the emergency care of patients presenting at an emergency room of the hospital 102, such as admission information, observations from emergency examinations of patients, treatments provided in the emergency room setting, etc. The PACS 110 stores medical images (e.g., x-rays, scans, three-dimensional renderings, etc.) as, for example, digital images in a database or registry. Images are stored in the PACS 110 by healthcare practitioners (e.g., imaging technicians, physicians, radiologists) after a medical imaging of a patient and/or are automatically transmitted from medical imaging devices to the PACS 110 for storage. The RIS 112 stores data related to radiology practices such as, for example, radiology reports, messages, warnings, alerts, patient scheduling information, patient demographic data, patient tracking information, and/or physician and patient status monitors, as well as enables exam order entry (e.g., ordering an x-ray of a patient) and image and film tracking (e.g., tracking identities of one or more people that have checked out a film). The lab information system 114 stores clinical information such as lab results, test scheduling information, corresponding practitioner(s), and/or other information related to the operation(s) of one or more labs at the corresponding healthcare facility. While example types of information are described above as being stored in certain elements of the hospital 102, different types of healthcare data may be stored in one or more of the entities 104-114, as the entities 104-114 and the information listed above is included herein as non-limiting examples. Further, the information stored in entities 104-114 may overlap and/or be combined into one or more of the entities 104-114. Each of the example entities 104-114 of FIG. 1 interacts with an electronic medical record (EMR) system 116. Generally, the EMR 116 stores electronic copies of healthcare records associated with, for example, the hospital 102 and the entities 104-114 thereof.

The example healthcare environment 100 of FIG. 1 also includes an outpatient clinic 118 as an example of another healthcare enterprise. The example outpatient clinic 118 of FIG. 1 includes a lab information system 120 and a PACS 122 that operate similarly to the corresponding entities of the example hospital 102. The lab information system 120 and the PACS 122 of the example outpatient clinic 118 operate according to specifically designed clinical workflows that differ between each other and the clinical workflows of the entities 104-114 of the hospital 102. Thus, differences in clinical workflows can exist between the entities of a healthcare enterprise and between healthcare enterprises in general.

In the illustrated example of FIG. 1, the hospital 102 and the outpatient clinic 118 are in communication with an ECIS 124 via a network 126, which may be implemented by, for example, a wireless or wired Wide Area Network (WAN) such as a private network or the Internet, an intranet, a virtual private network, a wired or wireless Local Area Network, etc. More generally, any of the coupling(s) described herein may be via a network. Additionally or alternatively, the example hospital 102 and/or the example outpatient clinic 118 are in communication with the example ECIS 124 via direct or dedicated transmission mediums 128 and 130.

Generally, the ECIS 124 supports healthcare information processing implemented by systems, devices, applications, etc. of healthcare enterprises, such as the hospital 102 and the outpatient clinic 118. The ECIS 124 is capable of processing healthcare messages from different entities of healthcare enterprises (e.g., the entities 104-114 of the hospital 102) that may generate, process and/or transmit the healthcare messages differently and/or using different formats, protocols, policies, terminology, etc. when generating, processing, and/or transmitting the healthcare messages. Moreover, the example ECIS 124 of FIG. 1 supports healthcare practitioners in decision making processes by aggregating healthcare information across disparate enterprises and/or entities thereof and referencing collection(s) of data to automatically generate suggestive and/or definitive data for communication to one or more healthcare practitioners related to the aggregated healthcare information.

Certain examples provide a library of standardized clinical content and proven best practices. Over time, this “library” of content may expand as healthcare organizations add to their own content modules. Because the content is standardized it can be shared and leveraged among organizations using the library and associated clinical knowledge platform. The library and platform help enable organizations to share best practice content. Thus, certain examples provide a clinical knowledge platform that enables healthcare delivery organizations to improve performance against their quality targets.

In certain examples, a quality dashboard application enables creation of one or more dashboards based on the data/content most relevant to an organization at a given period of time. A clinical knowledge platform brings together real-time patient data from existing IT systems within an organization and allows for the comparison of this data against evidence-based best practices. The example quality dashboard application leverages the platform to enable personalized “Quality Dashboards” to be created for specific sets of patients, based on condition, role, and/or other criteria. Variations from desired practice will be highlighted on each dashboard, enabling care providers to ensure better clinical outcomes and enrich patient care.

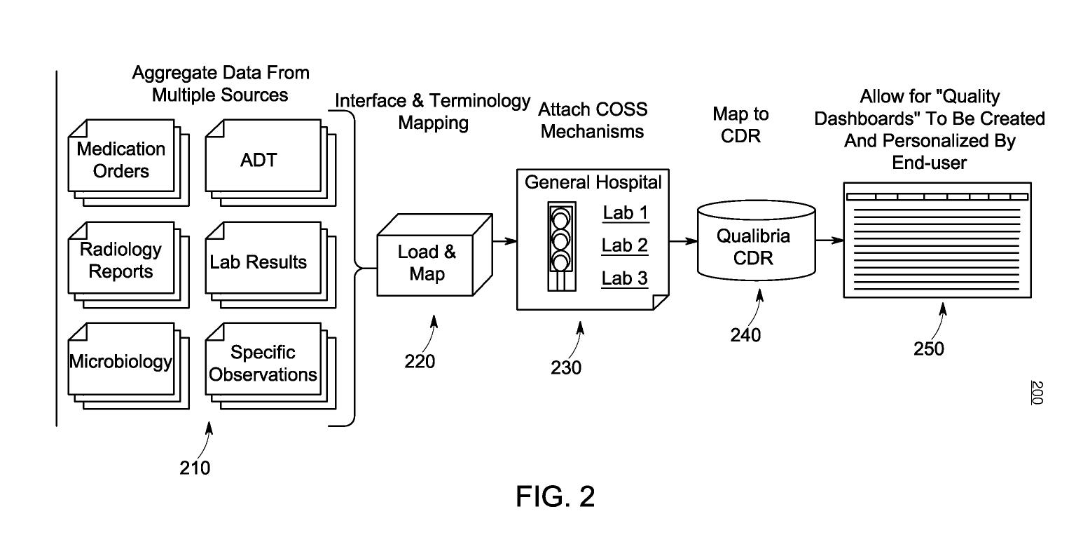

In this example, the clinical knowledge platform aggregates data from an organization's existing IT solutions. These can be solutions from the same and/or different manufacturer and/or provider. For example, as long as there is an HL7 or Web Services feed, the clinical knowledge platform can utilize the data from an existing solution. The existing IT solution(s) will continue to operate as they always have, and an organization can continue to use these solutions separate from the clinical knowledge platform if they so desire. However, the clinical knowledge platform and associated application(s) and/or workflow(s) can help to put organizations in greater control of their data by aggregating as much data from disparate IT solutions as possible. FIG. 2 illustrates an example clinical knowledge system 200 providing an aggregation 210 of data from multiple sources. Aggregated data may include, for example, medication orders, radiology reports, microbiology, admit/discharge/transfer (ADT) message, lab results, specific observations, electronic medical record (EMR) data, etc.

As the different data sources are pulled into a central data repository, content standardization occurs. It is this “standardization” that enables content from different IT sources to be used together. For example, as shown in FIG. 2, an interface 220 provides terminology mapping and standardization to the aggregated data.

After the content is standardized, clinical decision support mechanisms can be tied to the content (as illustrated, for example, by the clinical decision support 230 of the system 200 of FIG. 2). The data and associated clinical decision support are then stored in a clinical data repository (CDR), such as CDR 240 of the example system 200. By combining the aggregated and standardized data with clinical decision support rules and alerts, the clinical knowledge platform may provide end-users with an understanding of important elements to which they should pay attention (and take action on) within the larger set of data they are considering when caring for a patient.

Combined data and clinical decision support mechanisms create valuable content that, when arranged properly, may be used to improve the quality of care provided. Organizations can elect to use the application(s) that are provided as a part of the example clinical knowledge platform and/or may choose to build their own clinical application(s) on the platform. The open architecture nature of the platform empowers organizations to build their own vision, rather than base their vision on the static/hard coded nature of traditional IT solutions.

In certain examples, “Quality Dashboards” created via an example application display data via columns and rows in addition to individual patient “inspector” views. For example, the system 200 shown in FIG. 2 provides one or quality dashboards 250 to be created and personalized by an end user. The flexible nature of this dashboard application empowers organizations to create dashboards of the aggregated data based on their needs at a given period of time. The organization may determine what data elements they would like to include on each dashboard and, without significant IT resources, create a dashboard that reflects their vision. In addition, organizations can determine where on the dashboard they would like the information to be displayed and further adjust the view of the content via features such as “bolding” font, etc. When data is added to each dashboard, clinical decision support mechanisms attached to this data are displayed on the dashboard as well. For example, content related to treating a patient based on a particular use case may be included on a quality dashboard, along with alerts and notifications to indicate to end-users when desired outcomes are varying from defined clinical standards. Thus, organizations can create dashboards based on their own idea of “best practice” care for a given disease state.

In certain examples, since combined content and best practices have been standardized, content from one organization using the clinical knowledge platform may be easily shared with other organizations utilizing the platform. In addition, because the content within platform-related applications is standardized in the same manner, upgrades to the example platform can occur efficiently across organizations. That represents a dramatic change from prior IT solutions which require unique IT upgrades because they are usually uniquely customized to each organization in which they are installed.

Generally, content is information and experience that may provide value for an audience. Any medium, such as the Internet, television, and audio CDs, may deliver content as value-adding components. Content represents the deliverable, such as a DVD movie, as opposed to the delivery mechanism, a DVD player. As long as content conforms to the media standard, any compatible device can play it.

Content, as used herein, is the externalization or parameterization of “the instructions” that tell applications how to work. For example, content is a collection of externalized information that tells software, in conjunction with data, how to behave. In certain examples, a clinical knowledge platform takes in and executes content against data to render applications visually and behaviorally.

Content includes data read and interpreted by a program to define or modify presentation, behavior, and/or semantics of the program and/or of application data consumed by the program, for example. Content includes documents presented to a client by a program without modification, for example. Content may be created, stored, deployed, and/or retrieved independently of the creation and deployment of the program(s) consuming the data, for example. Content may be versionable to capture desired variation in program behavior and/or semantics, for example.

Classes of content may include configuration content, preferences content, reference content, application content, etc. Content types may combine behaviors of two or more classes, for example.

Software vendors take many different approaches to customization. At one extreme, some vendors write different software for each customer or allow customers to write software. At the other extreme, a vendor has the same software for each customer, and all customization occurs through creating or modifying content. In certain examples, the same software may be used for each customer, and customization is handled through content.

In healthcare, new laboratory tests, medications, and even diseases are constantly being discovered and introduced. Structuring this as content, where underlying software does not need to change, helps accommodate and use updated information.

In certain examples, many different content types, such as form definitions, data models, database schema, etc., are accommodated. In certain examples, each content type may be used differently and involve a distinct authoring tool. Thus, in certain examples, content may refer to “a collection of the content instances for all content types,” also called a content repository, knowledge repository, or knowledge assets. For example, a content instance is a specific member of a content type, such as a heart rate data model.

In certain examples, each content type is associated with a generic, extensible structure that content instances of the content type follows. An example clinical information system can specify content in an abstract way that does not presuppose a particular software implementation, for example. That is, another system, such as GE's Centricity Enterprise, may consume content from a knowledge repository, apply a different set of software, and achieve the same behaviors. Additionally, an abstract content definition can more easily transition to a new system. If one can extract content from a legacy system, a knowledge repository may be able to import and reuse it. Such a capability helps reduce a large barrier to change for potential customers.

Content can change with time. In an example, a current knowledge repository can handle any “old” data entered into a system under the auspices of an older knowledge repository. Occasionally, a question may arise where someone could ask, “What did Dr. Smith see at some past time?” Under these circumstances, a current definition of a particular display may not correctly reflect the situation at the time. An example CIS, unlike other systems, can bring back the old form for visualizing the data since all knowledge assets are versioned and retained.

Content may need to vary for different circumstances. For example, an MPV may differ between emergency department (ED) and labor and delivery settings. Each MPV has rows and columns of data specific to its setting. Context refers to being aware of and reacting distinctively to a location and other situational differences. For example, interpretation of a patient's low temperature can vary based on location. If it occurs in the recovery room after cardiopulmonary bypass with deliberate patient cooling, it means one thing. If the patient is in the ED after breaking through ice into a lake, it means something completely different. Context may vary based on user location, patient location, user role, and/or various other factors. In certain examples, content may be applied based on context.

Globalization is a process of adapting software so that it has no language references, before embedding capabilities to make it suitable for particular languages, regions, or countries. Having globalized it, a CIS may then translate it to other languages and cultures, called localization. Globalizing a software product involves creating content separate from the software. For example, embedded text (e.g., user messages), sort orders, radix characters, units of measure, data formats, currency, etc., may be removed and parameterized. References to languages, character sets, and fonts may also be removed, for example. In certain examples, while display representations may be local, terminology concepts are applied universally, making a rule, calculation, or other content based on one or more terminology concepts useable worldwide without modification.

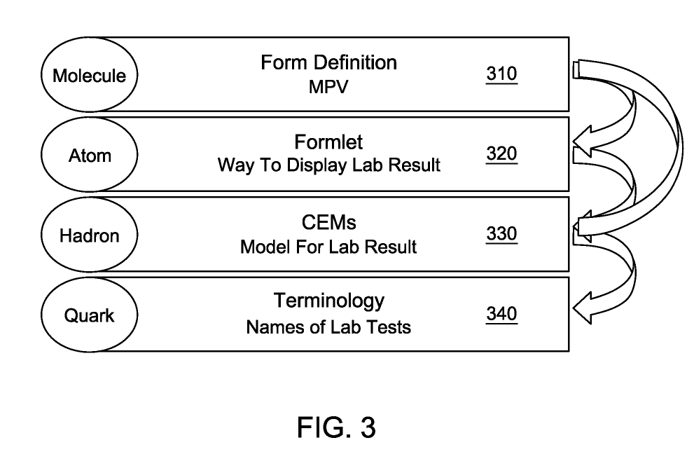

For example, FIG. 3 illustrates an example interdependence of content types. As shown in the example of FIG. 3, content is a set of interdependent building blocks. Content may be thought of as a hierarchy, with terminology 310 (e.g., names of lab tests) as a lowest level. Terminology 310 may be common and coded across a customer base. Clinical element models (CEMs) 320 govern structure and content of objects stored in a database and used by applications. A formlet 330 provides a way to display a particular content item (e.g., a way to display a particular lab result). A form definition 340 provides an application or view (e.g., a dashboard) of a collection of formlets (e.g., a multi-patient view (MPV) showing one or more lab results and/or other information). For example, if a particular MPV definition is moved from one customer to another, the MPV definition along with other content items on which the form definition depends are imported into the new customer's knowledge repository. Content items may include appropriate formlets, CEMs, and terminology, for example.

In certain examples, the Clinical Element Model presents a model for describing and representing detailed clinical information wherein each item of clinical information is defined using a detailed model of the information (that is, Detailed Clinical Models).

An example logical model to represent such a Detailed Clinical Model uses a two-layer data modeling approach in which the structure or representation of a clinical data object (that is, an instance of data) is separated from the definition of the information contained within the clinical data object (that is, a model defining the instance of data). This logical model defines the information in a Detailed Clinical Model as a set of constraints progressively limiting (and/or restricting) allowable data values in a Detailed Clinical Model until a specific clinical data item is defined.

In certain examples, a computer language, referred to as a Constraint Definition Language (CDL), is provided to define Detailed Clinical Models and constraints used to describe a specific clinical data item.

In certain examples, a detailed clinical model defines, at a granular level, the structure and content of a data element. For example, the detailed Clinical Model for “Heart Rate Measurement” dictates the data type of a heart rate measurement, and the valid physiologic range of a heart rate. It says that a “body location” is valid qualifying information about a heart rate measurement, but a “color” is not. It further decrees that the valid values for “body location” are terminology codes found in the “heart rate body location” value set. Moreover, it prescribes that a “resting heart rate” is an instance of “Heart Rate Measurement” where the value of “temporal context” is “resting”, where “resting” is also a coded value. A detailed clinical model pulls the information together into a single, explicit, and computable form. The detailed clinical models or clinical element models (CEMs) govern the content and structure of all data objects stored in an example clinical database and used by applications, for example. In addition, CEMs are extensible, such that content authors may add new CEMs or attributes to existing CEMs without requiring major changes to database structures or software, for example.

In certain examples, shared or portable content is, in effect, “plug 'n play”. System administrators can add it (e.g., plug it into) to a system without any software changes, and the content behaves in the intended way and does not cause errors. The size or scope of shared content can range from a single term to an entire knowledge repository, for example. Shared content fundamentally changes an implementation paradigm and reduces a total system cost of ownership, for example.

Customers can change shared content. Customers can improve it or make it more suitable for their institutions. When customers do this, they leave the original definition intact, but clone it and keep their changed version in their “local” space, for example.

As described above, classes of content may include configuration content, preferences content, reference content, application content, etc. Configuration content is content that is modified infrequently and is concerned primarily with system behavior, for example. Examples of configuration content may include internet protocol (IP) address and port of clinical knowledge database, identifiers of terminals in systems, security access privileges, configuration files, etc. Configuration content may affect program semantics, for example. Configuration content is generally modified by system administrators and is often stored in the file system, for example.

Preference content is modified frequently and is concerned primarily with variation between users. Examples of preference content include display colors and fonts, default search parameters, screen layout, etc. Preference content rarely affects program semantics and is most commonly modified by individual users. While modified by users, the system generally distributes initial or default preference content.

In certain examples, distributed or default preference content behaves very similar to application content before modification by a user. Preference content may be context sensitive, transformed at deployment, etc. Preference content may include vocabulary concepts and pick-lists that are resolved when loading and retrieving just like other content types.

Reference content is documents that are presented without modification as part of the application. Reference content is often stored in formats that are opaque to a program (e.g., as a PDF, a Microsoft Word™ document, etc.). Reference content is generally not specific to or customized for a specific patient (e.g., instruction sheets, information sheets, policies and procedures, etc.). Reference content may be independent of program semantics and behavior. Reference content may be authored independently of a program. While not an element of a content drive system per se, reference content is often managed as content by a clinical knowledge system. Once reference content is modified for presentation to a specific user, the content starts behaving much more like patient data/documents. Reference content with the structure to enable modification starts behaving much more like application content.

Application content may be modified frequently or infrequently depending on use. Application content may be concerned primarily with application behavior and semantics. Applicant content may be generally specific to an application domain. Examples may include a flow sheet template, clinical element models, terminology, document templates that are modified and stored as patient data (e.g., hot text), etc. Terminology is application content but has behaviors distinct from other application content types and is managed (largely) independently of other application content, for example. Application data often affects program semantics and behavior. Application content may be authored at multiple levels in an organization or external to the organization, for example.

Application content may be implemented as a custom markup language, for example. Application content may be implemented as a domain specific language (DSL), for example. For example, data queries may be implemented using a frame definition language (FDL). Clinical element models may be implemented using a constraint definition language (CDL). Application content may be directly authored or imported as data into a content store (e.g., concepts in a vocabulary server), for example.

In certain examples, while patient data is transactional and often includes discrete data elements, application content is often structured, complex objects and often has associated metadata. In certain examples, metadata is data used to manage content, such as content identifier, version, name of author, access privilege, encryption certificate, etc. Metadata is not treated as content, for example. While patient data is owned by a patient and is part of a legal record, application content is not owned by a patient and is not part of a legal record. Application content may be published (e.g., is not transactional) and managed using a lifecycle.

Certain examples provide content-driven systems and processes that rely primarily on content to determine application behavior. An example system includes a reference platform that consumes, interprets, and/or executes content while remaining application neutral. An example system uses content that remains independent of an implementation of the reference platform to allow independent evolution of the platform and the application.

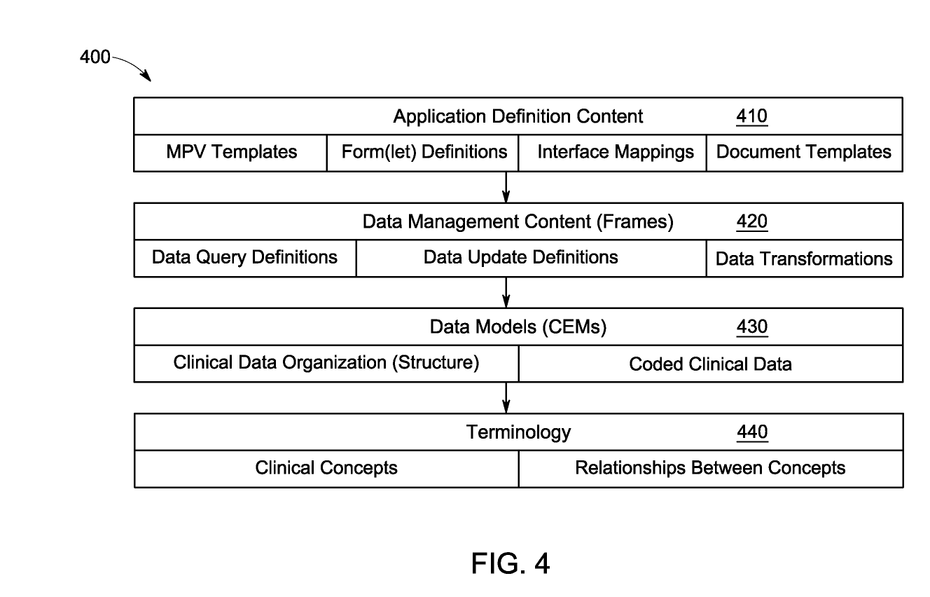

FIG. 4 illustrates an example hierarchy 400 of content, associated data models, and terminology. In certain examples, once one chooses content based data models, content-based queries and data management are also selected. Content based applications are also chosen. An integral terminology basis includes semantics of data defined in terminology content, for example. As shown in the example of FIG. 4, application definition content 410 (e.g., MPV templates, form(let) definitions, interface mappings, and/or document templates, etc.) relies on data management content (e.g., frames) 420 (e.g., data query definitions, data update definitions, and/or data transformations, etc.). The data management content 420 leverages data models (e.g., CEMs) 430, such as clinical data organization (e.g., structure) and/or coded clinical data, etc. The data models 430 are constructed based on a terminology 440 including clinical concepts and relationships between concepts, for example.

In certain examples, context refers to metadata attributes and/or labels that differentiate variations of a content item. For example, each variant of content item may be referred to as a context variant. Each variation of a content item has a specific set of context attributes (e.g., language, location, role, etc.). An algorithm or heuristic may select a desired variant when retrieving based on a current user's “context.” This process may be referred to as context resolution.

Searching refers to examining the content item and/or associated metadata for matches independent of context. Searching can include context attributes to filter for specific context variants in the search. The difference is that a specific variant is not selected algorithmically or heuristically by the content system when searching. Using the “user” as a context attribute is one way to associate a content item with a specific user; similarly provider as a context variable could be used to associate an item with a group of users. Resolving context generally requires some heuristic to resolve ambiguity or conflicts among context variants (e.g., weighting or priority schemes, default rules, etc.). This leads to some ambiguity since changing/adding a context variant or changing the weights of context attribute may change the context resolution on another item in not always obvious ways (at least to a user).

In certain examples, a content item includes:

1. A root content item represented by a universally unique identifier (UUID). The root content item includes metadata only; no actual content is stored.

2. One or more context variants that represent variations of an implementation of the content item in different client contexts occur as children of the root content item.

3. Context variants may form trees of increasing context specialization (e.g., a context variant may have child variants).

4. Each context variant has a unique UUID as well as a relation to the root content item.

5. Each context variant maintains versions of that variant as changes are applied to the variant.

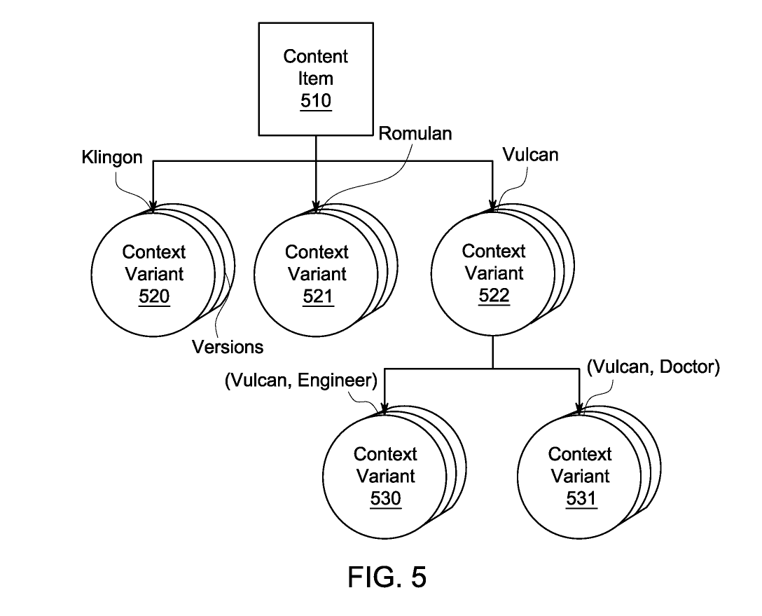

As shown in the example of FIG. 5, a root content item 510 has one or more content variants 520-522. Each content variant 520-522 may be associated with one or more context variants 530-531.

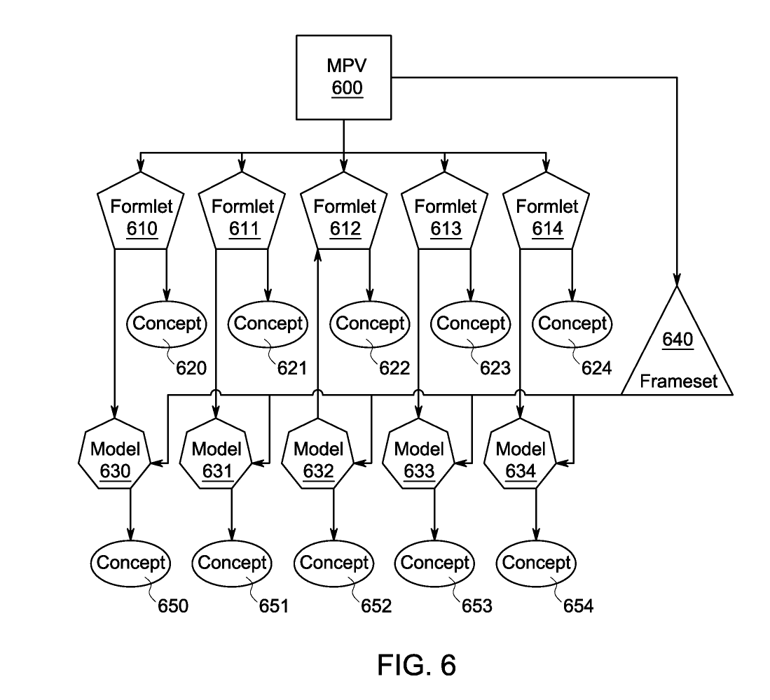

FIG. 6 provides an example multi-patient view (MPV) 600 made up of a plurality of formlets 610-614 and a frameset 640. Each formlet 610-614 corresponds to a concept 620-624 and a model 630-634. The frameset 640 is also associated with each model 630-634, and each model 630-634 is associated with a concept 650-654, for example.

In certain examples, content may be stored in multiple content stores. For example, content may be stored in an ECIS database, an XDS repository, a third-party system, etc. Content documents in storage may be identified by a URI that specifies the content store and the key of that item in that content store. A content directory including the content metadata may be searched to obtain the URI for retrieval of the content item. A content type manager may specialize the search, storage, and/or retrieval of items of that content type, for example.

A content item in the content directory is keyed via a UUID for the item. That UUID is not necessarily part of the uniform resource indicator (URI) that defines the storage location.

In certain examples, content items may be organized as a content type. A content type is a set of content items that are defined and managed using common definitions and methodologies (e.g., terminology, clinical element models, frameset definitions, etc.). Content types may have different behaviors, states, lifecycles, etc. Each content type may be managed by a specific content type manager, which is treated as a plug-in to a clinical knowledge platform and/or associated clinical information system, for example. Content types may be added by creating a new content type manager, for example.

Content type managers may interact with a content management framework by implementing a set of event handlers (e.g., package, deploy, retrieve, etc.). “Generic” content types (e.g., content types with no special behavior) may use a default content type manager. An owner of a content type is responsible for implementing an associated content type manager, for example.

In certain examples, during authoring (that is, before deployment), dependencies exist between content items. At runtime (that is, after deployment), dependencies exist between deployed forms of context variants. Dependents that exist during authoring may or may not continue after deployment. For example, terminology description and pick-list resolution are translations during loading and retrieving, not dependencies per se.

In certain examples, at runtime, dependencies are between deployed forms of context variants, not the context variants themselves. The deployed form of a context variant is a “content frame”. At deployment time, it may be necessary to guarantee that the packages (e.g., terminology) that a package depends on are also deployed. Terminology dependencies may be inferred from terminology relationships and mappings and do not need to be explicitly tracked.

In certain examples, a content based system provides a capability to distribute content and content updates to external instances (e.g., test systems, quality assurance systems, customer installations, content patches (SPRS), etc.). An example distribution system provides a capability to distribute content items and associated dependent content items and/or insure that those content items already exist in the target system. For example, an FDL content item must have access to the clinical element types it references in order to process a frame query. The example distribution system may also facilitate an undo or reversal of installed content items that generate issues. Content may be distributed as large sets of items (e.g., during installation) and/or as individual items (e.g., bug fixes), for example.

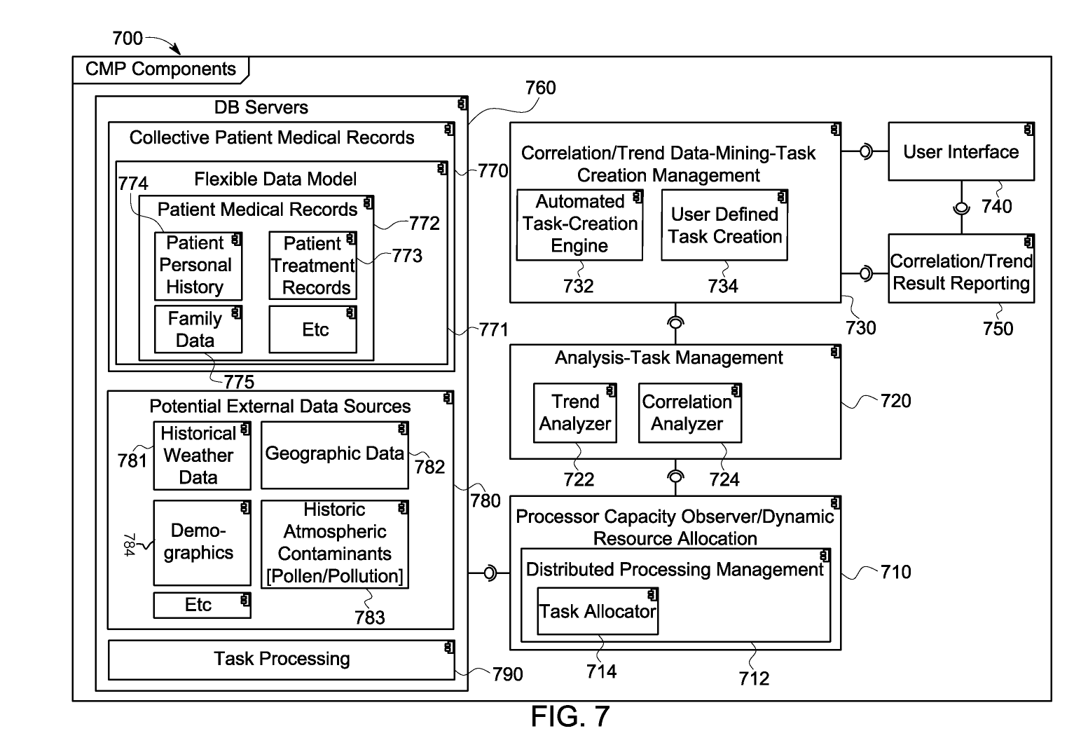

FIG. 7 illustrates an example decision support and trending system 700 to operate on clinical data, such as data formatted for clinical element models. The example system 700 includes one or more data stores 760 of information in communication with a process allocation manager 710, which is in communication with an analysis task manager 720 and a task creation manager 730. The system 700 also includes a user interface 740 and a results reporter 750. Components of the system 700 can be implemented together and/or separately in hardware, firmware, software, and/or a combination thereof.

The process allocation manager 710 illustrated in FIG. 7 includes a distributed process manager 712, which includes a task allocator 714, for example. The analysis task manager 720 includes a trend analyzer 722 and a correlation analyzer 724, for example. The task creation manager 730 includes an automated task creation engine 732 and a user-defined task creator 734, for example.

The data store(s) 760 illustrated in FIG. 7 includes collective patient medical records 770, one or more potential external data sources 780, and a task processor 790. The collective patient medical records 770 include a flexible data model 771 for one or more of the collective patient medical records 770. The flexible data model 771 includes patient medical records 772. The patient medical records 772 include patient treatment records 773, patient personal history 774, family data 775, etc. The potential external data sources 780 include historical weather data 781, geographic data 782, historic atmospheric contaminants 783, demographics 784, etc.

In operation, the example decision support and trending system 700 receives a request for data analysis via the user interface 740. The task creation manager 730 receives the request and creates one or more tasks for correlation and/or trending data mining via the user-defined task creator 734. Alternatively or in addition, one or more data mining tasks can be created by the automated task creation engine 732, with or without information from the one or more user requests. Thus, trending and/or data correlation can be performed in multiple ways. For example, a user can select the data that he or she wishes to have trended. In addition, trends can be dynamically identified and reported based on available data, for example.

The analysis task manager 720 receives and analyzes data according to specified correlation and/or trending tasks from the task creation manager 730. The processor capacity observer/dynamic resource allocator 710, including the distributed processing manager 712 and task allocator 714, distributes or allocates tasks associated with the specified correlation and/or trending among available processing resources.

Resources for task processing 790 are then allocated according to the processing manager 712 and task allocator 714 in the allocator 710. The task processor 790 leverages data from the patient medical records 770 in conjunction with one or more external data sources 780 to provide data for correlation and/or trending, for example.

The task processor 790 operates on clinical data, such as data formatted for clinical element models, to identify, automatically and/or at user request, correlations and/or trends in the data. Using the collective patient medical records 770, data from patient medical records 772 organized according to the flexible data model 771 (e.g., based on CEMs) can be mined and analyzed including patient treatment records 773, patient personal history 774, family data 775, etc. Data from the potential external data sources 780 including historical weather data 781, geographic data 782, historic atmospheric contaminants 783, demographics 784, etc., can also be mined and analyzed. Retrieved data can be provided to the process manager 712 and the analyzers 722, 724 for correlation/trend results reporting 750 and access via the user interface 740, for example.

An example of a possible correlation that the system 700 may find using data from the Clinical Element Model/data model information 770, 780 is as follows. Patient information in a patient medical record 771 can be formatted according to a Patient data model (a Patient CEM). The Patient model can include a VeteranMilitaryStatus model, for example. Patient medical records 772 can also include an AdmitDiagnosis model, for example. An external source 780 may include weather data 781, for example. By combining the VeteranMilitaryStatus model in the Patient model with the AdmitDiagnosis model and with Weather data from an external source, the system 700 can establish a possible correlation between a patient's military service, weather conditions, and a diagnosis for the patient, for example.

When trends/correlations are found between this data among a sufficient group of patients (e.g., a threshold number of patients) such that the correlation becomes statistically significant, the system 700 raises an alert for clinician review. For example, the trend analyzer 722 and/or the correlation analyzer 724 of the analysis task manager 720 can identify the pattern and trigger an alert output in the results reporting 750 and/or trigger an alert from the manager 730 to the user interface 740.

In certain examples, new data models can be created and added (e.g., automatically by the system 700, by the user via the user interface 150 and/or other update/input, by the system 700 with confirmation by the user, etc.) to capture additional information. In certain examples, the data models evolve to reflect new information of interest.

In certain examples, information for correlation with patient conditions includes natural disasters, military personnel service activities, living in a home with lead paint, etc. Clinicians are finding new correlations all the time, which can be used to supplement information and/or analysis in the system 700. Conversely, information identified by the system 700 can be used to supplement a clinician's analysis, for example. In certain examples, the system 700 employs “creative” or adaptive discovery to look for correlations based on existing and/or new knowledge.

The examples described herein may restructure and/or aggregate data, such as patient data and associated lab and/or observation data received in different formats into one structured format (e.g., Extensible Markup Language) using one or more scripts deployed at run time. For example, first data received in a first format may be parsed and formatted in a structured format (e.g., tree structure having parent and child relationships) and second data received in a second format and associated with the first data may be parsed and formatted in the structured format and aggregated with the first data. Parsing the data enables relevant data to be identified and/or extracted and saved for future use. In some examples, an observation may include data in different objects including actual data, comments, reference ranges, etc. Using the examples described herein, data associated with the observation may be parsed and aggregated into one structured object useable in decision support and/or to collect patient data. In some examples, depending on the clinical data received, alerts may be generated to aid in decision support and added to a header at the parent level and/or the child level of the data structuring. In some examples, the data stored in the object may include codes and/or structures that are fully validated.

In some examples, a hook may be exposed in the process flow that dynamically introduces scripts that intercept the process flow and aggregate, modify, parse, filter, etc., data into a structured format based on the data received. The scripts may be customizable plugins executed at one or more stages within the process flow. One of the stages may be prior to the data being transformed into and/or mapped to the internal data structure (e.g., pre-mapping script) and/or one of the stages may be after the data has been transformed into and/or mapped to the internal data structure (post-mapping script). A script that may intercept the process flow after the data has been transformed into the internal data structure may be an appender plug-in script. In some examples, the appender plug-in script may append all observation values from incoming messages associated with the same observation (e.g., each having the same key code and/or Observation ID) into one string that may be stored as one object that is persisted by the system. Such an approach may be advantageous when observation values include carriage returns at their ends. Using the appender, the carriage returns may be filtered from the observation values. The observation values without the carriage returns may then be aggregated and/or appended for storage. In other examples, microbiology specimen observation data may be received in differently formatted segments. Using an example script, the segments may be aggregated, parsed to extract relevant information by separating out data embedded in text form, if applicable, and stored in a structured format. In some examples, data of related segments may be aggregated while unrelated segments may not.

The scripts may be displayed in a tree structure that may be selected by the user. The selected scripts may be executed based on the message type received without having to shut the system down. The scripts may be provided to the customer and/or the scripts may be written and/or modified by the customer, for example.

In some examples, data may be dynamically modeled based on the data and/or content received using an example customizable data structure modeling tool deployable without shutting the system down. The example tool may aggregate patient laboratory and/or observation data received from various systems and store this data in a customizable and/or dynamically configurable data structure. For example, the examples described herein may capture, parse and/or aggregate data (e.g., different segments) related to an observation and received from different sources into a unit of observation for storing in a structured fashion including codes and/or structures that may be fully validated. In some examples, alerts may be set up that aid in decision support based on the data received. The data, once stored, may be retrieved and/or used to aid in clinical decision support. Because data from different sources may be organized in a structured format, such as a CEM and/or other flexible data model, the examples described herein may aid in meaningful use stage 3 measures for a specific patient to arrive at national health statistics by the national health department.

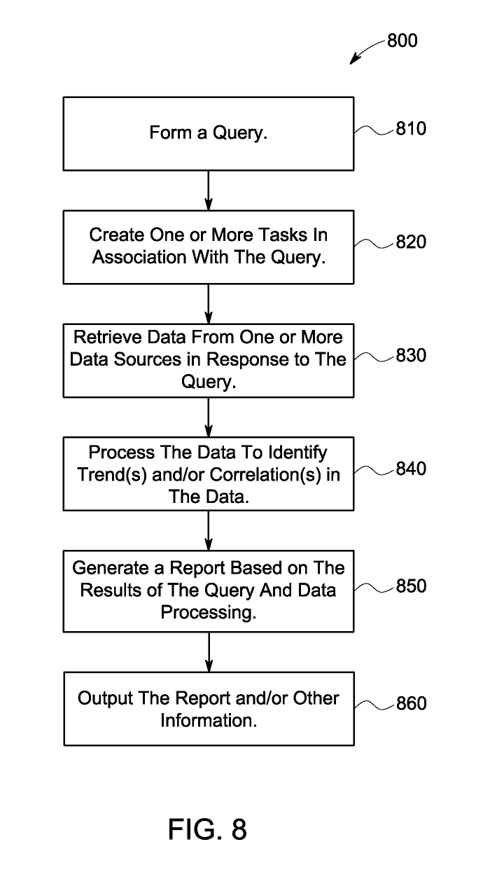

FIG. 8 illustrates a flow diagram for an example method 800 of dynamic, on-going decision support and trending based on a flexible data model. The flexible data model allows patient medical records to be structured to include a variety of information (e.g., patient personal history, patient treatment records, family data, etc.) to be structured for searching, processing, and analysis but yet configurable to establish relationships and correlations between elements, for example.

At block 810, a query is formed. The query can be generated by a user and/or automatically generated by the system based on past queries and/or observations, for example. In certain examples, during a system idle or low usage time, the system can automatically generate random queries for information and then process results of those queries to determine if an unknown trend and/or correlation exists. Output from these “random” queries can be combined and/or used to supplement user-driven queries to provide dynamic analysis and decision support to a user, such as a clinician.

At block 820, one or more tasks are created in association with the query. Tasks can be created based on a user-directed query and/or an automated system search, for example, and can relate to identifying one or more trends and/or correlations in available data, for example.

At block 830, data is retrieved or otherwise identified from one or more data sources in response to the query. For example, one or more data sources, such as patient medical records, external data sources, etc., can be queried for data in accordance with the user- and/or system-formulated query. Data can be organized according to a flexible data model, such as a CEM, data model, etc.

At block 840, the retrieved data is processed to identify trend(s) and/or correlation(s) in the data. Correlations and/or trends can be identified based on past patterns and/or other prior information, user input, rules, thresholds, etc. Analysis can be divided into a plurality of tasks, each with different information, constraints, objectives, etc. At block 850, a report is generated based on results of the query and data processing. For example, one or more identified trends and/or correlations can be reported. One or more alarms can be reported based on the identified trend(s)/correlation(s), for example. One or more next actions, best practices, and/or other decision support can be reported based on the identified trend(s)/correlation(s) (or lack thereof), for example. At block 860, the report and/or other information is output. For example, the report and/or other information can be displayed to a user via a user interface on a display. The report and/or other information can be saved, printed, transmitted, etc. One or more next actions and/or options can be made available to the user via the user interface, for example.

Note that correlation and trending tasks can be constructed after the data is retrieved in response to a query. Alternatively or in addition, task processing can be distributed before and/or after data is retrieved in response to the query.

While an example manner of implementing systems and methods have been illustrated in the figures, one or more of the elements, processes and/or devices illustrated in the figures may be combined, divided, re-arranged, omitted, eliminated and/or implemented in any other way. Further, one or more components and/or systems may be implemented by hardware, software, firmware and/or any combination of hardware, software and/or firmware. Thus, for example, any of the example components and/or systems may be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the example components and/or systems are hereby expressly defined to include a tangible medium such as a memory, DVD, Blu-ray, CD, etc., storing the software and/or firmware. Further still, any of the example systems may include one or more elements, processes and/or devices in addition to, or instead of, those illustrated in the figures, and/or may include more than one of any or all of the illustrated elements, processes and devices.

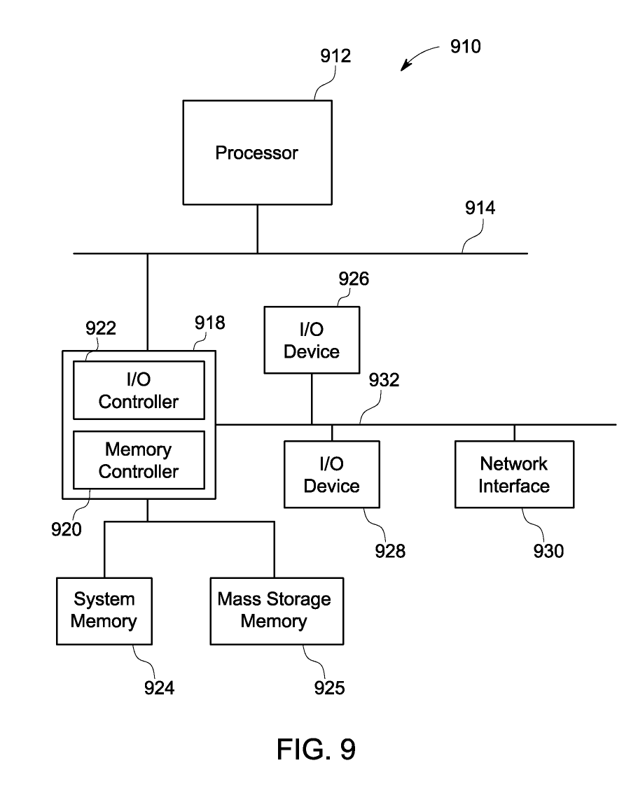

The flow diagrams depicted in the figures (e.g., FIG. 8) are representative of machine readable instructions that can be executed to implement example processes and/or systems described herein. The example processes may be performed using a processor, a controller and/or any other suitable processing device. For example, the example processes may be implemented in coded instructions stored on a tangible medium such as a flash memory, a read-only memory (ROM) and/or random-access memory (RAM) associated with a processor (e.g., the example processor 912 discussed below in connection with FIG. 9). Alternatively, some or all of the example processes may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes may be implemented manually or as any combination(s) of any of the foregoing techniques, for example, any combination of firmware, software, discrete logic and/or hardware. Further, although the example processes are described with reference to the figures, other methods of implementing the processes of may be employed. For example, the order of execution of the blocks may be changed, and/or some of the blocks described may be changed, eliminated, sub-divided, or combined. Additionally, any or all of the example processes of may be performed sequentially and/or in parallel by, for example, separate processing threads, processors, devices, discrete logic, circuits, etc.

FIG. 9 is a block diagram of an example processor system 910 that may be used to implement the apparatus and methods described herein. As shown in FIG. 9, the processor system 910 includes a processor 912 that is coupled to an interconnection bus 914. The processor 912 may be any suitable processor, processing unit or microprocessor. Although not shown in FIG. 9, the system 910 may be a multi-processor system and, thus, may include one or more additional processors that are identical or similar to the processor 912 and that are communicatively coupled to the interconnection bus 914.

The processor 912 of FIG. 9 is coupled to a chipset 918, which includes a memory controller 920 and an input/output (I/O) controller 922. As is well known, a chipset typically provides I/O and memory management functions as well as a plurality of general purpose and/or special purpose registers, timers, etc. that are accessible or used by one or more processors coupled to the chipset 918. The memory controller 920 performs functions that enable the processor 912 (or processors if there are multiple processors) to access a system memory 924 and a mass storage memory 925.

The system memory 924 may include any desired type of volatile and/or non-volatile memory such as, for example, static random access memory (SRAM), dynamic random access memory (DRAM), flash memory, read-only memory (ROM), etc. The mass storage memory 925 may include any desired type of mass storage device including hard disk drives, optical drives, tape storage devices, etc.

The I/O controller 922 performs functions that enable the processor 912 to communicate with peripheral input/output (I/O) devices 926 and 928 and a network interface 930 via an I/O bus 932. The I/O devices 926 and 928 may be any desired type of I/O device such as, for example, a keyboard, a video display or monitor, a mouse, etc. The network interface 930 may be, for example, an Ethernet device, an asynchronous transfer mode (ATM) device, an 802.11 device, a DSL modem, a cable modem, a cellular modem, etc. that enables the processor system 910 to communicate with another processor system.

While the memory controller 920 and the I/O controller 922 are depicted in FIG. 9 as separate blocks within the chipset 918, the functions performed by these blocks may be integrated within a single semiconductor circuit or may be implemented using two or more separate integrated circuits.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM, DVD, Blu-Ray, or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

1. A clinical data analysis system comprising:
a user interface to facilitate user input and provide output to the user regarding a data query and analysis;
a task manager to create and manage one or more analyzers to identify at least one of a trend and a correlation in query results; and
a process manager to facilitate querying of one or more data sources according to the data query and a flexible data model, the process manager to allocate tasks to the one or more analyzers for the data query and analysis,
wherein the process manager and task manager are to facilitate user queries and automated system queries performed automatically during periods of non-peak usage, and
wherein the flexible data model is to facilitate dynamic modification of the data model by the user such that data organized according to the modified data model is to be automatically available for analysis.

2. (canceled)

3. The system of claim 1, wherein dynamic modification includes an addition of at least one of a field and a model to the flexible data model.

4. The system of claim 1, wherein the automated system queries are to be constructed to randomly attempt to correlate unrelated data.

5. The system of claim 1, wherein the task manager is to compute at least one of correlation and trending based on one or more specified fields.

6. The system of claim 5, wherein trending is to be configured via a rules engine allowing customizations dynamically without code changes.

7. The system of claim 1, wherein the task manager is to generate an alert notification to a user.

8. The system of claim 1, wherein data to be queried comprises clinical data and non-clinical data.

9. The system of claim 1, wherein the automated system queries are to be constructed using previous searches to run similar searches, wherein statistically relevant correlation among search results is to be further process to identify additional correlations.

10. A non-transitory computer-readable storage medium including a set of instructions, which when executed by a processor, implement a clinical data analysis system, the system comprising:
a user interface to facilitate user input and provide output to the user regarding a data query and analysis;
a task manager to create and manage one or more analyzers to identify at least one of a trend and a correlation in query results; and
a process manager to facilitate querying of one or more data sources according to the data query and a flexible data model, the process manager to allocate tasks to the one or more analyzers for the data query and analysis,
wherein the process manager and task manager are to facilitate user queries and automated system queries performed automatically during periods of non-peak usage, and
wherein the flexible data model is to facilitate dynamic modification of the data model by the user such that data organized according to the modified data model is to be automatically available for analysis.

11. (canceled)

12. The computer-readable storage medium of claim 10, wherein dynamic modification includes an addition of at least one of a field and a model to the flexible data model.

13. The computer-readable storage medium of claim 10, wherein the automated system queries are to be constructed to randomly attempt to correlate unrelated data.

14. The computer-readable storage medium of claim 10, wherein the task manager is to compute at least one of correlation and trending based on one or more specified fields.

15. The computer-readable storage medium of claim 14, wherein trending is to be configured via a rules engine allowing customizations dynamically without code changes.

16. The computer-readable storage medium of claim 10, wherein the task manager is to generate an alert notification to a user.

17. The computer-readable storage medium of claim 10, wherein data to be queried comprises clinical data and non-clinical data.

18. The computer-readable storage medium of claim 10, wherein the automated system queries are to be constructed using previous searches to run similar searches, wherein statistically relevant correlation among search results is to be further process to identify additional correlations.

19. A computer-implemented method of clinical data query and analysis, the method comprising:
formulating a data query for clinical data, the data query comprising at least one of a user-generated query and an automatically-generated query;
creating, using a processor, one or more analyzers to identify at least one of a trend and a correlation in query results;
facilitating, using a processor, querying of one or more data sources according to the data query and a flexible data model, the processor to allocate tasks to the one or more analyzers for the data query and analysis; and
providing analysis results in an output to a user,
wherein the processor and the one or more analyzers are to facilitate user queries and automated system queries performed automatically during periods of non-peak usage, and
wherein the flexible data model is to facilitate dynamic modification of the data model by the user such that data organized according to the modified data model is to be automatically available for analysis.

20. (canceled)

21. The method of claim 19, wherein dynamic modification includes an addition of at least one of a field and a model to the flexible data model.

22. The method of claim 19, wherein the automated system queries are to be constructed to randomly attempt to correlate unrelated data.

23. The method of claim 19, wherein data to be queried comprises clinical data and non-clinical data.
